(19) United States
(12) Patent Application Publication
(10) Pub. No.: US 2007/0286247 A1
(43) Pub. Date: Dec. 13, 2007

(54) Frequency-doubled laser resonator including two optically nonlinear crystals

(76) Inventors: H. Yang Pang, San Jose, CA (US); David Dudley, Montara, CA (US); Jean-Marc Heritier, Sunnyvale, CA (US); Norman Hodgson, Belmont, CA (US)

Correspondence Address: STALLMAN & POLLOCK LLP, 353 SACRAMENTO STREET, SUITE 2200, SAN FRANCISCO, CA, 94111, US

(21) Appl. No.: 11/805,632

(22) Filed: May 24, 2007

Related U.S. Application Data
(60) Provisional application No. 60/812,878, filed on Jun. 12, 2006.

(51) Int. Cl. H01S 3/11; H01S 3/10; H01S 3/081; H01S 3/082

(52) U.S. Cl. 372/10; 372/22; 372/93; 372/97

(57) ABSTRACT

An intracavity frequency-doubled includes a laser resonator including at least one gain element and two optically nonlinear crystals. The two optically nonlinear crystals independently double the frequency of fundamental radiation in the resonator. In one example the crystals are arranged to generate two frequency-doubled beams that are orthogonally plane-polarized with respect to each other. The beams can be combined by a polarization-selective combiner to form a common output.

### PRIORITY CLAIM

This application claims priority to U.S. Provisional Patent Application No. 60/812,878, filed Jun. 12, 2006, the complete disclosure of which is hereby incorporated by reference.

### TECHNICAL FIELD OF THE INVENTION

The present invention relates in general to harmonic generation in lasers. The invention relates in particular to intracavity frequency-doubling in a solid-state laser resonator.

### DISCUSSION OF BACKGROUND ART

When higher second-harmonic output power is needed from a laser cavity, higher intra-cavity power is required. Due to cavity gain and loss factors and laser resonator design, the intra-cavity power would reach a limit at a certain level, therefore ultimately limiting the second-harmonic power generation. Power output coupling represented by percentage of harmonic conversion at this limit is not necessarily the optimum for cavity (laser resonator) operational conditions. One loss factor additional to output coupling is intra-cavity doubling induced beam aberration. When the harmonic conversion efficiency is high, a significant amount of the fundamental beam is converted to the second harmonic, leaving center part of the transverse intensity distribution of the fundamental beam depleted. This partial transverse beam depletion causes the beam to lose its Gaussian characteristics and results in high cavity loss. Another limitation on second-harmonic generation is optical damage induced by the absorption of the second-harmonic in the optically nonlinear crystal generating the second-harmonic. Any of the foregoing will reduce the efficiency of second-harmonic generation. There is a need for a resonator arrangement for optimizing second-harmonic power output of frequency-double solid state lasers.

### SUMMARY OF THE INVENTION

In one aspect, laser apparatus in accordance with the present invention comprises a laser resonator terminated by at least first and second end-mirrors. At least one gain-element is located in the laser resonator. An arrangement is provided for energizing the gain-element for causing laser radiation having a fundamental frequency to circulate in the laser resonator. First and second optically nonlinear crystals are located in the laser resonator, each thereof arranged to double the frequency of the circulating fundamental-frequency radiation, thereby generating frequency-doubled (second harmonic) radiation.

In one preferred embodiment of the present invention there are first and second gain-elements located in the laser resonator. The first optically nonlinear crystal is located between the first end-mirror and the first gain-element, and the second optically nonlinear crystal is located between the second end-mirror and the second gain-element. The resonator is folded by first and second fold-mirrors, each thereof reflective for the fundamental-frequency radiation and transmissive for the frequency-doubled radiation. The first fold-mirror is located between the first gain-element and the first end-mirror, and the second fold-mirror is located between the second gain-element and second end-mirror. The first gain-element is arranged such that frequency-doubled radiation generated thereby is plane-polarized in a first plane and the second gain-element is arranged such that frequency-doubled radiation generated thereby is plane-polarized in a second plane perpendicular to the first plane.

In another embodiment of the invention the resonator can be divided into first and second branches by a polarization-selective optical element. The first branch is terminated by the first and second end-mirrors and the second branch is terminated by the first end-mirror and a third end-mirror. The first optically nonlinear crystal is located in the first resonator branch between the polarization-selective optical element and the second end-mirror, and the second optically nonlinear crystal is located in the second resonator branch between the polarization-selective optical element and the third end-mirror. The frequency doubled-radiation generated by the optically nonlinear crystals in each of the resonator branches exits the resonator, via the polarization-selective optical element, along a common path.

### BRIEF DESCRIPTION OF THE DRAWINGS

FIG. 1 schematically illustrates one preferred embodiment of a diode-pumped Q-switched frequency-doubled solid-state laser in accordance with the present invention including first and second mirrors terminating a laser resonator folded at each end by respectively first and second fold mirrors, first and second gain-modules in the laser resonator for generating fundamental radiation, a Q-switch located between the two gain modules, and first and second optically nonlinear crystals for frequency-doubling the fundamental radiation, with the first crystal located between the first terminating mirror and the first fold mirror and the second crystal located between the second terminating mirror and the second fold mirror.

FIG. 2 schematically illustrates another preferred embodiment of a diode-pumped Q-switched frequency-doubled solid-state laser in accordance with the present invention similar to the laser of FIG. 1 but wherein the resonator is not folded, the Q-switch is located between the first terminating mirror and the first gain module, the resonator is divided into first and second branches by a polarizing beamsplitter with the first branch terminated by the second mirror and the second branch terminated by a third mirror, and wherein the first and second crystals are located in respectively the first and second resonator branches.

### DETAILED DESCRIPTION OF THE INVENTION

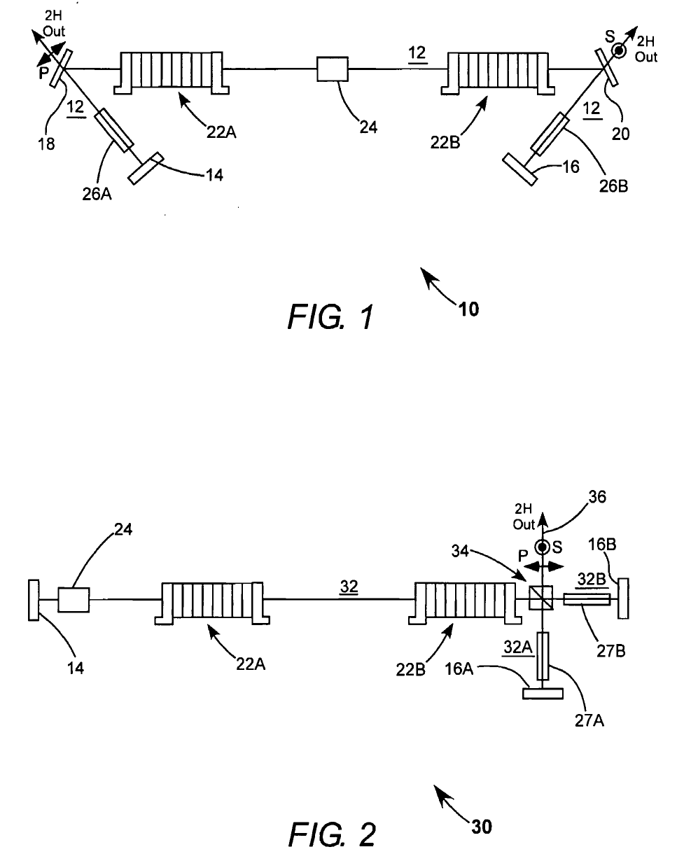

Referring now to the drawings, wherein like features are designated by like reference numerals FIG. 1 schematically illustrates one preferred embodiment 10 of a diode-pumped Q-switched frequency-doubled solid-state laser in accordance with the present invention. Laser 10 includes a resonator 12 terminated by mirrors 14 and 16 and folded at each end by fold mirrors 18 and 20. Located in the resonator are spaced apart gain-modules 22A and 22B. A Q-switch 24 is located between the two-gain modules preferably equidistant from each. The Q-switch provides for pulsed operation of the resonator.

The gain modules, here, comprise an Nd:YAG gain medium surrounded by radially arranged diode-laser bars with radiation from the diode laser bars directed laterally into the gain-medium. Details of the modules are not shown but this type of lateral pumping of a solid-state gain medium is well-known in the art and a detailed description thereof is not necessary for understanding principles of the present invention. The present invention is not limited to this type of gain-medium or this type of pumping.

The gain modules are preferably essentially identical and pumped at the same power, such that the thermal lensing in each is about the same. The modules are periodically arranged in the resonator, that is, the gain modules are spaced such that the thermal lens of each gain medium provides that a circulating beam of fundamental radiation has one beam waist at each terminating mirror and another waist between the gain modules. Mirrors 14 and 16 are highly reflective at the wavelength of the fundamental radiation and also highly reflective at the wavelength of frequency doubled fundamental radiation.

First and second optically nonlinear crystals 26A and 26B respectively are provided for frequency-doubling the fundamental radiation. Crystal 26A is located close to mirror 14 between mirror 14 and fold mirror 18. Crystal 26B is located close to mirror 16 between mirror 16 and fold mirror 20. This arrangement provides that the crystals are positioned at the natural beam-waist locations at the terminating mirrors discussed above, thereby optimizing the second-harmonic (2H) conversion efficiency of the crystals. Second-harmonic radiation (2H-radiation) is generated on a double pass of the fundamental radiation through each crystal. Fold mirrors 18 and 20 have high transmission at the second-harmonic wavelength to couple the second-harmonic radiation out of the resonator, and have high reflectivity at the fundamental wavelength.

Axes of the crystals are preferably oriented with respect to each other such that the second-harmonic beam generated by one crystal is polarized orthogonal to that generated by the other. Second-harmonic beams are output at each of the fold mirrors. The orthogonal polarization orientation of one beam with respect to the other is indicated by double arrows P and arrowhead S. This orthogonal polarization-orientation provides that the beams can be combined by a polarizing beamsplitter device (not shown) to propagate on a common path. The length of the optical paths of the beams to the combining device can be arranged to be equal in length such that laser pulses in the beams temporally exactly overlap to provide pulses having the sum of the peak-power of those in the individual beams. Alternatively, the path lengths can be made different to cause only partial temporal overlapping or no temporal overlapping of the beams such that that average power of the combined beam is the sum of the average powers of the individual beams but the peak power is no higher than the highest in any of the individual beams.

When two optically nonlinear crystals are used in a high power laser cavity in accordance with the present invention, the power output coupling can be tuned or detuned by adjusting a critical phase-matching angle of the crystal to adjust the harmonic-generation percentage to accommodate higher or lower amount of available pump-power, i.e., available fundamental power. It has been determined that over 40% more second-harmonic power can be generated than can be generated by a single crystal in the same resonator. Power output coupling can also be tuned with non-critically phase-matched optically nonlinear crystals by varying the phase-matching temperature of the crystals.

In one example of laser 10, wherein spacing between the gain modules is 700 millimeters (mm) and spacing between the terminating mirrors and the gain modules is 350 mm, and wherein crystals 28A and 28B are LBO (lithium borate) crystals arranged for type-II frequency-doubling, 340 W (total) of 532 nm radiation was generated by frequency-doubling 1064 nm fundamental radiation. With only one of the LBO crystals in the resonator only 240 W 532 nm power was generated in only one beam.

FIG. 2 schematically illustrates another preferred embodiment 30 of a diode-pumped Q-switched frequency-doubled solid-state laser in accordance with the present invention. Laser 30 is similar in principle to the laser of FIG. 1 but architecturally different. In laser 30 a resonator 32, including two gain modules 22A and 22B, is divided into two branches 32A and 32B by a bi-prism type polarizing beamsplitter 34. Branch 32A is terminated by mirror 14 and a mirror 16A, and branch 32B is terminated by mirror 14 and a mirror 16B. Mirrors 14, 16A, and 16B are highly reflective at the wavelength of the fundamental radiation and also highly reflective at the wavelength of frequency doubled fundamental radiation. Clearly, fundamental radiation circulating in one branch of the resonator will be polarized in a plane perpendicular to that fundamental radiation circulating in the other branch of the laser resonator.

Q-switch 24 is located between mirror 14 and gain module 22A. One optically nonlinear crystal 27A is located in resonator-branch 32A between the beamsplitter and mirror 16A. Another optically nonlinear crystal 27B is located in resonator-branch 32B between the beamsplitter and mirror 16B.

Optically nonlinear crystals 27A and 27B are each arranged for type-I frequency-doubling in which the frequency-doubled radiation is plane-polarized in a plane perpendicular to the plane of polarization of the radiation being frequency-doubled. Frequency-doubled radiation generated by crystal 27B is reflected by polarizing beamsplitter 34 out of the resonator being S-polarized with respect to the beamsplitter as indicated by arrowhead S. Frequency-doubled radiation generated by crystal 27A is transmitted by polarizing beamsplitter 34 out of the resonator, being P-polarized with respect to the beamsplitter as indicated by double arrows P. The P-polarized output radiation propagates on a common path 36 with the S-polarized output radiation as indicated in FIG. 2.

Those skilled in the art will recognize from the description of laser 30 provided above that resonator could also be divided into two branches by a front-surface polarizing beamsplitter. The front surface polarizing could be designed to be effective for both the fundamental and 2H wavelengths with outputs along a common path. Alternatively a separate polarizing beamsplitter for the 2H wavelength could be included in each branch (between the resonator-dividing beamsplitter and the optically nonlinear crystal) such that 2H radiation is directed out of the resonator as two separate beams.

It is emphasized here that in lasers 10 and 30 2H-radiation is generated in one of the optically nonlinear crystals independent of the 2H-generation by the other, although, of course, both contribute to output coupling losses. In laser 10 of FIG. 1, the crystals are in the same resonator but the location of the crystals, cooperative with two dichroic fold-mirrors 18 and 20, provides that one crystal does not receive any significant amount of 2H-radiation generated. In laser 30 the crystals are in separate resonator branches and are essentially completely isolated one from the other by the polarizing beamsplitter.

In any of the above described embodiments, a pair of crystals generating 2H-radiation in the same polarization orientation and cooperative with each other for compensating for walk-off losses could be substituted for the single crystals at the ends of the common resonator of laser 10 or in the separate resonator branches of laser 30 without departing from the spirit and scope of the present invention. Further, it should be noted that while embodiments are described above with reference to resonators in which there are two spaced-apart gain modules, principles of the invention are applicable to resonators including only a single gain-element.

In summary, the present invention is discussed above in terms of a preferred and other embodiments. The invention is not limited, however, to the embodiments described and depicted herein. Rather the invention is defined by the claims appended hereto

What is claimed is:

1. Laser apparatus, comprising:
a laser resonator terminated by at least first and second end-mirrors;
at least one gain-element located in the laser resonator;
an arrangement for energizing the at least one gain-element for causing laser radiation having a fundamental frequency to circulate in the laser resonator; and first and second optically nonlinear crystals located in the laser resonator each thereof arranged to independently double the frequency of the circulating fundamental-frequency radiation thereby generating frequency-doubled radiation.

2. The apparatus of claim 1, wherein there are first and second gain-elements located in the laser resonator, the first optically nonlinear crystal is located between the first end-mirror and the first gain-element and the second optically nonlinear crystal is located between the second end-mirror and the second gain-element.

3. The apparatus of claim 2, wherein the resonator is folded by first and second fold-mirrors, each thereof reflective for the fundamental-frequency radiation and transmissive for the frequency-doubled radiation, with the first fold-mirror being located between the first gain-element and the first end-mirror, and with the second fold-mirror being located between the second gain-element and second end-mirror.

4. The apparatus of claim 3, wherein the first gain-element is arranged such that frequency-doubled radiation generated thereby is plane-polarized in a first plane and the second gain-element is arranged such that frequency-doubled radiation generated thereby is plane-polarized in a second plane perpendicular to the first plane.

5. The apparatus of claim 1, wherein the resonator is divided into first and second branches by a polarization-selective optical element, the first branch being terminated by the first and second end-mirrors and the second branch being terminated by the first end-mirror and a third end-mirror, with the first optically nonlinear crystal being located in the first resonator branch between the polarization-selective optical element and the second end-mirror, and with the second optically nonlinear crystal being located in the second resonator branch between the polarization-selective optical element and the third end-mirror.

6. The apparatus of claim 5, wherein frequency double-radiation generated by the optically nonlinear crystals in each of the resonator branches exits the resonator via the polarization-selective optical element along a common path.

7. The apparatus of claim 5, wherein the polarization-selective element is a biprism-type polarizing beamsplitter.

8. The apparatus of claim 5, wherein the optically nonlinear crystals are arranged for type-I frequency-doubling.

9. Laser apparatus, comprising:
a laser resonator terminated at first and second ends thereof by first and second end-mirrors and folded near said first and second ends thereof by respectively first and second fold mirrors;
at least one gain-element located in said laser resonator between said first and second fold mirrors, said at least one gain-element, when energized, causing laser radiation having a fundamental frequency to circulate in the laser resonator;
a first optically nonlinear crystal located in said laser resonator between said first end-mirror and said first fold mirror;
a second optically nonlinear crystal located in said laser resonator between said second end-mirror and said second fold mirror; and
each of said optically nonlinear crystals arranged to independently double the frequency of the circulating fundamental-frequency radiation thereby generating frequency-doubled radiation.

10. The apparatus of claim 9, wherein there are two gain-elements located in said laser resonator between said first fold mirror and said second fold mirror.

11. The apparatus of claim 9, wherein said first optically nonlinear crystal is arranged to generate frequency-doubled radiation polarized in a first polarization plane and said second optically nonlinear crystal is arranged to generate frequency-doubled radiation polarized in a second polarization plane perpendicular to said first polarization plane.

12. The apparatus of claim 9, wherein said first and second mirrors are highly reflective for the fundamental radiation and highly transmissive for said frequency-doubled radiation for delivering respectively first and second frequency-doubled output beams from said laser resonator.

13. The apparatus of claim 9, wherein said first and second optically nonlinear crystals are arranged for type-II frequency-doubling.

14. Laser apparatus, comprising:
a laser resonator divided into first and second branches by a polarization-selective element;
said first resonator-branch terminated by a first end-mirror and a second mirror and said second resonator branch terminated by said first mirror and a third mirror;
at least one gain-element located in said laser resonator between said first end-mirror and said polarization-selective element, said at least one gain-element, when energized, causing laser radiation having a fundamental frequency to circulate in both branches of the laser resonator;
a first optically nonlinear crystal located in said first branch of said laser resonator between said second end-mirror and said polarization-selective element;
a second optically nonlinear crystal located in said second branch of said laser resonator between said third end-mirror and said polarization-selective element; and
wherein each of said optically nonlinear crystals is arranged to independently double the frequency of the circulating fundamental-frequency radiation, thereby generating frequency-doubled radiation.

15. The apparatus of claim 14, wherein said first optically nonlinear crystal is arranged to generate frequency-doubled radiation polarized in a first polarization plane and said second optically nonlinear crystal is arranged to generate frequency-doubled radiation polarized in a second polarization plane perpendicular to said first polarization plane.

16. The apparatus of claim 14, wherein said first and second optically nonlinear crystals are arranged for type-I frequency-doubling.

17. The apparatus of claim 14, wherein said polarization-selective element is a polarizing beamsplitter arranged to reflect frequency-doubled radiation generated by said first optically nonlinear crystal out of said first branch of the laser resonator and transmit frequency-doubled radiation generated by said second optically nonlinear crystal out of said second branch of the laser resonator.

18. The apparatus of claim 17, wherein said polarizing beamsplitter combines said reflected and transmitted frequency-doubled radiations on a common path.
